(19) United States
(12) Patent Application Publication
(10) Pub. No.: US 2003/0224817 A1
(43) Pub. Date: Dec. 4, 2003

(54) Mobile communication apparatus

(76) Inventors: William J. Stewart, Blakesley (GB); John B. Pendry, Cobham (GB)

Correspondence Address: Kirschstein, Ottinger,, Israel & Schiffmiller, P.C., 489 Fifth Avenue, New York, NY, 10017-6105, US

(21) Appl. No.: 10/400,123

(22) Filed: Mar. 26, 2003

(30) Foreign Application Priority Data
Mar. 28, 2002 (GB) 0207358.3

(51) Int. Cl. H04M 1/00

(52) U.S. Cl. 455/550.1; 455/575.7

(57) ABSTRACT

A mobile communication apparatus such as a mobile phone has an antenna which includes magnetically permeable material surrounded by a coil connected to a radio frequency source and/or receiver. Unlike the normal dipole antenna of a mobile phone, the magnetic antenna results in reduced absorption of the evanescent, non-radiative field of the antenna in the user.

### BACKGROUND OF THE INVENTION

This invention relates to mobile communication apparatus, such as mobile telephones or pagers.

Typically, such apparatus has a short electric dipole as an antenna. Dipoles respond to the electric vector of received electromagnetic radiation, or launch electromagnetic radiation when driven by an electric voltage. Coil antennas, which respond to the magnetic vector or are driven by electric current, are also well known. For example, radio receivers are sometimes fitted with coils wound around a magnetically permeable material such as ferrite, but such antennas have not been fitted in mobile phones or pagers because the ferrite material does not have a high permeability at high frequencies at which the handsets operate (of the order of 2 GHz).

The field around any antenna consists of two components, namely, a radiative component and an evanescent component. The radiative component is energy-carrying and decays quadratically with distance from the antenna, making it long range. This is the intended radiation from the antenna and its intensity more than a wavelength or so from it is determined by the antenna's required function. The evanescent component decays exponentially (i.e., much more steeply) away from the antenna and does not carry energy away from it. At ranges less than a wavelength or so, this component may well be larger than the radiative component and contribute more to losses in local materials.

In the case of a mobile phone, the losses in local materials could include losses in the human brain, and thus constitute a potential hazard.

The evanescent component generally grows in intensity compared to the radiative component, as the antenna gets smaller.

In addition, the required drive voltage given for a given far-field radiation level also increases as the antenna gets smaller. In the case of mobile phones, this is inconvenient in view of the low voltage low power electronics used.

### SUMMARY OF THE INVENTION

The invention provides mobile communication apparatus, comprising a radio frequency source and/or receiver, and an antenna which includes magnetically permeable material comprising at least one component having inductance and capacitance, the component having a dimension in one direction being less than a wavelength of radiation in a band of frequencies at which the mobile communication apparatus is arranged to operate.

With such a magnetic antenna, the evanescent component is largely magnetic rather than electric in form (the radiative component will be similar in general form and in intensity to that from an electric antenna) and, because loss mechanisms in biological tissues are thought to operate on the electric field, this will reduce the absorption in the first few millimeters or centimeters away from the antenna where the evanescent field dominates. This reduced absorption becomes more marked for smaller antennas. While a small antenna size will still require an increased drive for a given radiation level, a magnetic antenna requires an increased drive current rather than voltage, which is easier to produce in low power electronics. As with an electric antenna, increased drive does not require increased power since the evanescent fields do not radiate.

Advantageously, the magnetically permeable material comprises an array of components having inductance and capacitance, the component dimension in one direction and the array spacing being less than the wavelength of radiation in the band of frequencies at which the mobile communication apparatus is arranged to operate. Structures comprising an array of such components are described in Magnetism From Conductors and Enhanced Non-Linear Phenomena, J. B. Pendry, A. J. Holden, D. J. Robbins and W. J. Stewart, IEEE Transactions on Microwave Theory and Techniques, 1999, 47, 2075-2084 and International Patent Application No. WO 00/41270 and No. WO 01/67550. These microstructures can be designed to show quite large positive permeability in the radio frequency range, for example, at GHz. Typically the elements are spaced at less than a fifth of the wavelength of the radiation at which the microstructure is resonant, but they could be spaced by greater amounts (less than one half of the resonant wavelength for example), or lesser amounts (less than one tenth, or less than one hundredth), of the resonant wavelength, for example.

One form which the elements of such a microstructure can take is a roll of conducting sheet, the turns of which are separated by insulating material (a so-called “Swiss roll” structure). Inductance is provided by currents circulating around the curved wall of the Swiss rolls, and capacitance is provided by the self-capacitance between the inner and outer ends of the roll.

The radio frequency to which the microstructure is tuned is the frequency to which each element is tuned.

### BRIEF DESCRIPTION OF THE DRAWINGS

Mobile communication apparatus constructed in accordance with the invention will now be described in greater detail, by way of example, with reference to the accompanying drawing, in which:

FIG. 1 is a block diagram of the antenna, transmitter and receiver; and

FIG. 2 is a schematic perspective view of the antenna of the mobile communication apparatus.

### DETAILED DESCRIPTION OF THE PREFERRED EMBODIMENT

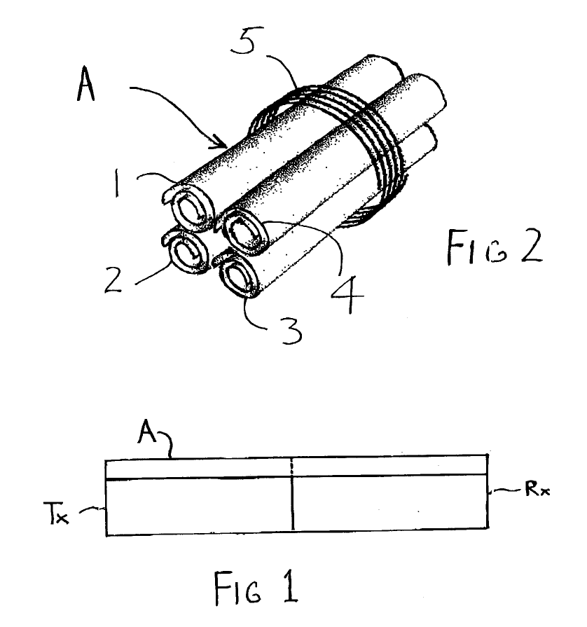

The mobile communication apparatus is a mobile telephone but could be a data unit. It has a transmitter Tx, a receiver Rx, and an antenna A which overlies the transmitter and receiver (FIG. 1). The antenna is shown schematically in FIG. 2.

The antenna shown in FIG. 2 consists of four Swiss roll structures, as described above. The Swiss rolls 1 to 4 are surrounded by a coil 5 which is connected to the radio frequency source/receiver Tx, Rx. Each Swiss roll consists of a layer of conducting material such as copper on an insulating substrate such as a plastics material. Each Swiss roll is manufactured by being closely wound onto a mandrel of appropriate size, and the Swiss rolls are then close packed together as shown in the drawing.

Typical dimensions for the Swiss rolls could be a millimeter in diameter, with metal thickness of a few microns and dielectric thickness of a few tens of microns. While four Swiss rolls have been illustrated, in practice more could be used typically within the range of from 1 to 100.

The resonant frequency of the antenna is almost the same as that of each individual Swiss roll, which is determined by the dimensions, predominantly the coil diameter and turn spacing. The bandwidth of the magnetically permeable material will normally be sufficient to cover the bandwidth of operation of the mobile phone. However, if desired, the individual Swiss rolls could be tuned to slightly different frequencies, for example, to two individual frequencies, or to several individual frequencies, over the bandwidth of operation of the mobile phone.

As an alternative to the Swiss rolls, other forms of resonant elongate means having capacitance and inductance, arranged in an array to form a microstructured material, may be used. For example, split cylinders or columns of printed loops, both those described in International Patent Application No. WO 00/41270, could be used.

While the mobile communication apparatus described is a mobile phone, the invention is equally applicable to pagers or other data communications units designed to be small and portable (e.g., cards for laptop computers).

It will be understood that each of the elements described above, or two or more together, also may find a useful application in other types of constructions differing from the types described above.

While the invention has been illustrated and described as embodied in a mobile communication apparatus, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A mobile communication apparatus, comprising:
a) a radio frequency source and/or receiver; and
b) an antenna which includes magnetically permeable material comprising at least one component having inductance and capacitance, said at least one component having a dimension in one direction which is less than a wavelength of radiation in a band of frequencies at which the mobile communication apparatus is arranged to operate.

2. The mobile communication apparatus as claimed in claim 1, in which the magnetically permeable material comprises an array of components having inductance and capacitance, the dimension of each component in said one direction and an array spacing between the components being less than the wavelength of radiation in the band of frequencies at which the mobile communication apparatus is arranged to operate.

3. The mobile communication apparatus as claimed in claim 1, in which said at least one component comprises a roll of conducting sheet having turns separated by an insulating material.

4. The mobile communication apparatus as claimed in claim 2, in which each component comprises a roll of conducting sheet having turns separated by an insulating material.

5. The mobile communication apparatus as claimed in claim 3, in which the roll has a diameter which is less than the wavelength of radiation in the band of frequencies at which the mobile communication apparatus is arranged to operate.

6. The mobile communication apparatus as claimed in claim 4, in which each roll has a diameter which is less than the wavelength of radiation in the band of frequencies at which the mobile communication apparatus is arranged to operate.
